(19) United States
(12) Patent Application Publication
(10) Pub. No.: US 2013/0250121 A1
(43) Pub. Date: Sep. 26, 2013

(54) METHOD AND SYSTEM FOR RECEIVING SURVEILLANCE VIDEO FROM MULTIPLE CAMERAS

(71) Applicant: ON-NET SURVILLANCE SYSTEMS, INC., Pearl River, NY (US)

(72) Inventors: Gadi Piran, Pearl River, NY (US); Shmuel Diamant, Pearl River, NY (US); James A. Walsh, Pearl River, NY (US); Morten T. Nielsen, Pearl River, NY (US)

(73) Assignee: On-Net Survillance Systems, Inc., Peal River, NY (US)

(21) Appl. No.: 13/849,054

(22) Filed: Mar. 22, 2013

Related U.S. Application Data
(60) Provisional application No. 61/614,961, filed on Mar. 23, 2012.

(51) Int. Cl. H04N 7/18

(52) U.S. Cl. CPC H04N 7/181
USPC 348/159

(57) ABSTRACT

A video compositing device includes a communication device that communicates with a video receiver station over a network and receives video streams from various video sources. The compositing device stores configuration settings, which indicate the size, position, zoom and/or color depth for views in a composite image that is formed from the video streams. The compositing device uses the video streams to generate the composite image as indicated by the configuration settings and transmits the composite image to the video receiver station. The compositing module also receives from the video receiver station information indicating a change in one or more one of the size, position, zoom or color depth of a selected view in the composite image, and then updates the configuration settings to reflect these changes. Subsequent composited images are generated in accordance with the updated configuration settings.

### CROSS-REFERENCE TO RELATED APPLICATIONS

This application claims the benefit of U.S. Provisional Application No. 61/614,961, filed Mar. 23, 2012, the contents of which are incorporated herein by reference.

### BACKGROUND OF THE INVENTION

1. Field of the Invention

Various embodiments generally relate to camera equipment. More specifically, preferred embodiments disclose methods and related systems that can receive video streams from multiple video cameras.

2. Description of the Related Art

A video system, such as a surveillance system, frequently employs multiple video cameras mounted at strategic viewing locations, each of which transmits a video signal to a remote location, such as a surveillance center, by way of a network. Typically, these multiple video feeds are multiplexed onto the network and received by a monitor or a personal computer having a monitor, where each feed is displayed in a corresponding reduced view (i.e, a view with a reduced resolution) within a matrix on the monitor. A user interface may enable the user to select, for example, a view and expand it to its full, transmitted size.

A significant problem with such systems, however, is that the bandwidth required of the network to supply the video feeds to the personal computer or monitor directly increases with the video bandwidth requirements of each video camera. Consequently, adding additional video cameras, using higher-definition video cameras, or both, significantly increases the bandwidth demands on the underlying network carrying the multiplexed video information.

There therefore exists a need for improved methods and related systems relating to security cameras that can avoid network bandwidth bottleneck issues.

### SUMMARY OF THE INVENTION

A video system and related method include a video compositing device. The video compositing device comprises a communication device that communicates with a video receiver station over a network and to that also accepts a video streams from various video sources. The compositing device has a memory that stores configuration settings, which indicate one or more of a size, position, zoom or color depth for views in a composite image that is formed from the video streams. The compositing device has a compositing module that utilizes the video streams to generate the composite image as indicated by the configuration settings. The compositing module then uses the communication device to transmit the composite image to the video receiver station. The compositing module also utilizes the communication device to receive from the video receiver station information indicating a change in one or more one of the size, position, zoom or color depth of a selected view in the composite image. The compositing module then updates the configuration settings to reflect these changes, and subsequent composited images are generated in accordance with the updated configuration settings, thereby changing the size, position, zoom or color depth of the selected view in the subsequent composited images.

In preferred embodiments the video receiver station comprises at least one central processing unit (“CPU”) to control operations of the video receiver station, networking hardware to communicate with the video compositing device over the network, a user input device, a display to display composited images and memory. The memory stores program code executable by the CPU to cause the CPU to utilize the networking hardware to receive the composite image from the remote device, present the received composite image on the display, and accept input from the user input device to indicate a change to at least one of the size, position, zoom or color depth of a view in the composite image. In response to such a change, the CPU of the video receiver station then uses the networking hardware to transmit to the video compositing device the information corresponding to the change to the size, position, zoom or color depth of the user-selected view.

Preferably, the video receiver station has a configuration file or the like that stores configuration settings for the composited image, and shares with the video compositing device this configuration file. The video compositing device then generates composited images in accordance with the shared configuration file. In this manner, updates on the screen of the video receiver station appear dynamic to the user.

In some embodiments at least one of the video sources is a video recorder, and the compositing module utilizes the communication device to control a pause, rewind or fast forward function of the video recorder.

In other embodiments the compositing module is configured to buffer in the memory a plurality of images from one or more of the video sources and then utilize a corresponding buffered image in accordance with an instruction received from the video receiver station when generating the composite image. In this manner, the video compositing device can function as a video recorder for each of the video streams as desired by the end user in the video receiver station.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention, but are merely presented to clarify illustrated embodiments of the invention. In these drawings:

FIG. 1 is block diagram of a system according to an embodiment of the invention.

FIG. 2 is a block diagram of a compositor module according to an embodiment of the invention.

FIG. 3 is a block diagram of a receiver station according to an embodiment of the invention.

FIG. 4 illustrates a matrix of views presented on a video monitor according to an embodiment of the invention.

FIG. 5 illustrates a compositor system according to another embodiment of the invention.

### DETAILED DESCRIPTION OF THE PREFERRED EMBODIMENTS

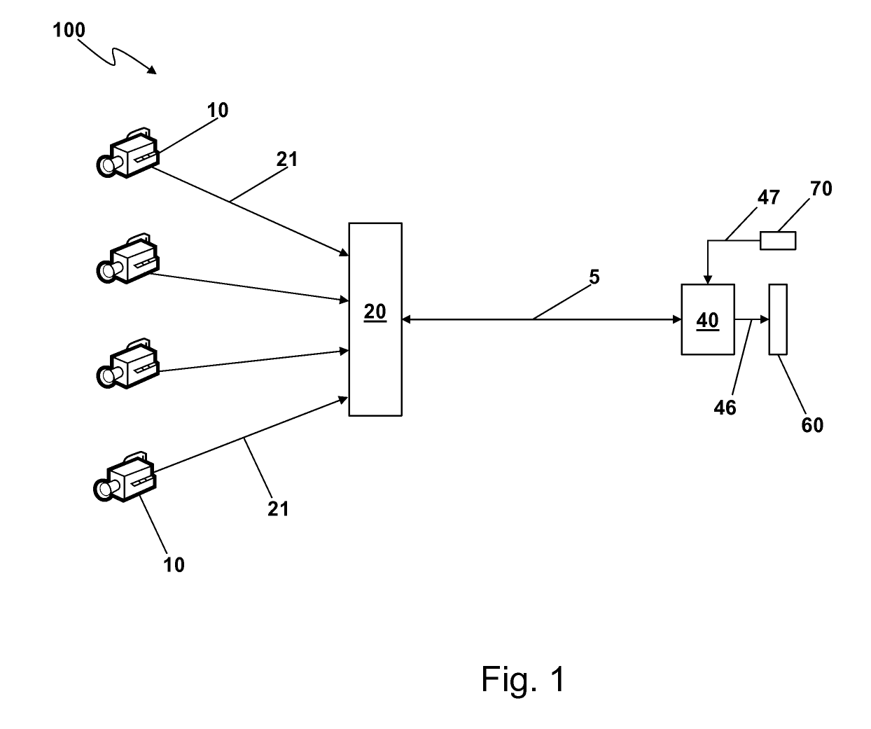

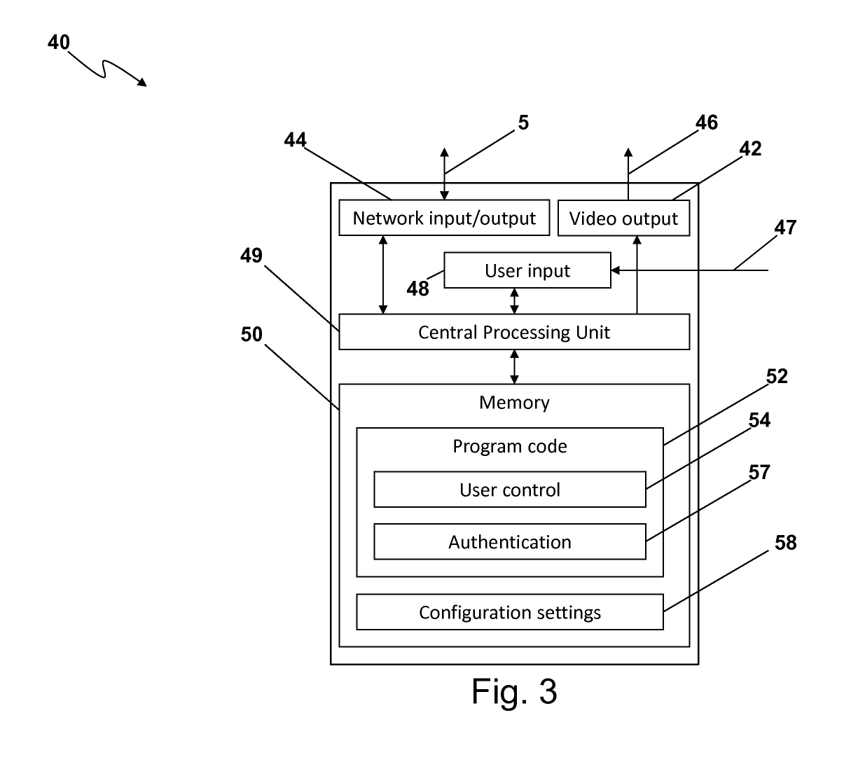

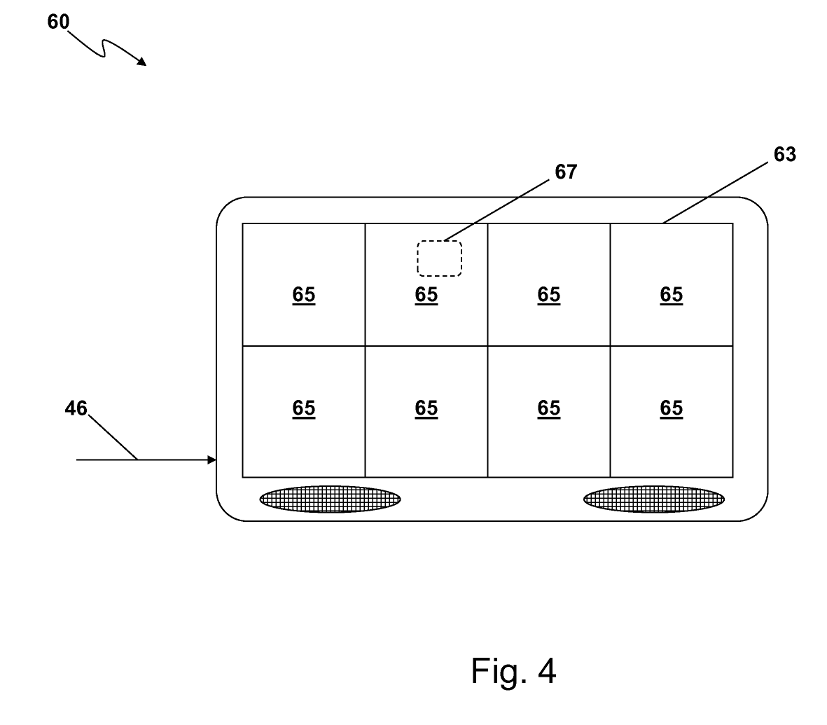

An embodiment system 100 capable of practicing a method according to an embodiment of the invention is shown in FIGS. 1-4. In a method according to an embodiment of the invention, a plurality of individual video data streams, such as video signals 21, are collected, as from video cameras 10. The video data streams 21 may comprise analog video data or digital video data, including packetized video data, in accordance with any suitable protocol. A desired selection of these video streams 21 (i.e., all or a subset thereof) are then processed so that their sizes are substantially equal to the sizes of corresponding views 65 within a video matrix 63 presented on a surveillance monitor 60. The result is a composited digital image 33 that has a size (in terms of pixel resolution) that is substantially equal to the size of the matrix 63. For example, assume that the matrix 63 presented on the monitor 60 is N×M pixels in size, which is subdivided into V₁ to V_{c} views 65, each with a corresponding size of n₁×m₁ . . . n_{c}×m_{c} pixels, which are respectively used to view video imagery I₁ . . . I_{c} 21 respectively generated by C₁ to C_{c} selected video sources 10 (i.e., there could be more video sources 10, but C are currently desired or selected for viewing purposes). Further assume that each video source 10 generates a corresponding native video image stream 21 that is respectively X₁×Y₁ . . . X_{c}×Y_{c} pixels in size. To generate a composited digital image 33 that is N×M pixels in size, for each native video image stream Iᵢ 21, its size Xᵢ×Yᵢ is reduced to the size nⁱ×mᵢ of its corresponding view Vᵢ 65, and placed into its corresponding view 35 within the composited digital image 33. This process is repeated C times, with “i” ranging from 1 to C, so that a completed composite image 33 is generated that includes all C video image streams 21 from all C selected video sources 10 in the form of C views 35, but which is substantially the same size as the matrix 63 presented on the end video monitor 60. This composited digital image 33 is then transmitted across any suitable network 5 to a receiver station 40. The receiver station 40 uses the received composited digital image 33 to generate a corresponding video signal 46 that is transmitted to the monitor 60. As a result, the bandwidth requirements of the embodiment method upon the network 5 is determined not by the video sources 10, but instead by the resolution of the client monitor 60, the desired size of the matrix 63 or both. Further, changing the resolution of the video sources 10, and resultant native video image streams 21, the number of video sources 10, or both, will not affect the bandwidth demands placed upon the network 5.

When generating the composited digital image 33, any suitable image reduction algorithm may be employed to reduce the resolution of each native video image stream 21 to generate the corresponding view 35, while remaining as true as possible to the visual impression of the image stream 21; examples of image scaling algorithms include, but certainly are not limited to, bilinear and bicubic interpolation. Further, the color depth of each image stream 21 may optionally be changed to conform to the corresponding color depth of the view 65 within the surveillance display matrix 63. Consequently, if an operator does not want or need color imagery for a particular view 65, the operator may indicate this using a suitable input device 70, such as a keyboard, mouse or the like, in conjunction with a user interface provided by the receiver station 40. As a result, when processing the corresponding native video stream 21, the color depth may be reduced to grey-scale, thus potentially further reducing the bandwidth demands on the network 5. Simply by way of example, a 640×480 video image stream 21 having 24 bits of color depth may be reduced to a 160×120 image having an 8-bit grey-scale color depth for use in a view 35 of composited digital image 33. Hence, on the monitor 60, such a video image stream 21 will present within a corresponding view 65 as an 8-bit grey-scale image that is 160×120 pixels in size.

As indicated above, a preferred embodiment method contemplates generating the composited digital image 33 in accordance with instructions received from the receiver station 40. For example, the receiver station 40 may indicate the ordering, positioning, respective resolutions and color depths of each view 65, and the composited digital image 33 is generated accordingly. Zooming of specific video image streams 21 is thus possible; by zooming, it is understood that this means that a region of interest, which is a sub-region within the respective image 21, is expanded to fill a larger portion or the entire respective view. For example, if it is desired that a specific video image stream 21 be viewed within the monitor 60 at maximum size, then when composing the composite image 33, the desired video image stream 21 may be given the greatest size possible within the composite image 33, potentially excluding other image streams 21 or causing them to be significantly reduced in size. Any suitable user interface present on the surveillance receiver station 40 side, in conjunction with one or more user input devices 70, may be used to indicate, change or both any one or more of the ordering, positioning, respective resolutions (and consequently sizes) and color depths of each view 65.

As shown in FIGS. 1-4, the system 100 according to an embodiment of the invention includes a plurality of video cameras 10 in communications with a compositor module 20 to provide a respective plurality of native video streams 21 to the compositor module 20. Any suitable protocol may be used to communicatively couple the video cameras 10 to the compositor module 20, including both wired and wireless connections. Typically a wired connection is used, such as coaxial cable or the like, but other arrangements are certainly possible.

The purpose of the compositor module 20 is to generate the composited digital image 33 from the input video streams 21, which image 33 is then transmitted via any suitable network 5 to the receiver station 40, as well as to control the composition of the composited digital image 33, such as the size (i.e., resolution or pixel size), position and color depth of the various views 35. In a preferred embodiment, the compositor module 20 comprises one or more central processing units (“CPUs”) 26, memory 30 in communications with the CPU(s) 26, and input/output devices 22 and 24 also in communications with the CPU(s) 26, which together serve as a communication device for communications with external devices. The memory 30 includes program code 34 that is executed by the CPU(s) 26 to cause the CPUs 26 to control the overall operations of the module 20 and thereby obtain the desired functionality. For purposes here and in the following, “executed” is intended to mean the processing of program code that results in desired steps being performed, and includes program code that is directly processed by a CPU, such as machine code (or object code), as well as program code that is indirectly processed but which nonetheless directs the operations of the underlying device, such as interpreted or runtime-compiled code, including without limitations Java, HTML, Flash or the like. Program code thus includes any suitable set of instructions that are executable by a CPU, as executed is understood herein, and can include machine code, interpreted or runtime-compiled code, and combinations thereof. It will also be appreciated that although in the following description reference is made to a composited digital image, it is understood that this can include not merely one but a plurality of such images, and further that memory used to store one or more such images may be repetitively written over again to support the continuous creation of new composited digital images.

A programmed model is preferred (i.e., using one or more CPUs 26 executing program code 34) to provide a compositing module, as it enables flexibility in configuring the module 20 by way of updates to the program code 34. However, it will be appreciated that hardware-only implementations, using digital logic, analog circuitry or combinations thereof may also be employed to obtain the desired functionality of the compositor module 20.

The communication device provided by the input/output devices 22 and 24 includes video inputs 22 that receive the various video streams 21 and make them available in digital form to the CPU(s) 26, and networking hardware 24 that receives commands from the receiver station 40 via the network 5, and which transmits the composited digital image 33 to the receiver station 40 over the network 5. In some embodiments, video streams 21 may also be received from the network 5 via the networking hardware 24. Any suitable video input hardware 22 and networking hardware 24 may be employed, including both wired and wireless solutions. It will therefore be appreciated that the video streams 21 are contemplated as including both analog video data, digital video data and video data carried in a packetized form, as known in the field of video processing. In preferred embodiments the networking hardware 24 supports the TCP/IP protocol, however any suitable hardware and logical protocols can be used.

The memory 30 may include volatile memory, non-volatile memory or combinations thereof, as known in the art. In addition to the program code 34 stored in the memory 30, the memory 30 is also used to store data, including memory used as a video scratch pad 32 to generate and store the composite image 33, and memory used to store configuration settings 38.

The configuration settings 38 may store information relevant to the generation of the composited digital image 33, such as the position, size, location, color depth and related video source 21 of each view 35; the update rate at which the composited digital image 33 is generated, such as two images 33 per second, ten images 33 per second, etc, and the size (for example, in pixels) of the composited digital image 33. Hence, the configuration settings 38 may indicate which video streams 21 are to be used to build the composited digital image 33, and thus indicate which cameras 10 are to be used in the overall matrix 64, as well as the viewing area on the monitor 60 to be devoted to each camera 10. The program code 34 is configured to receive instructions from the receiver station 40 via the network 5 and to update the configuration settings 38 in accordance with the instructions received. Any suitable protocol may be used to provide the instructions to the compositor module 20, including, for example, packet-based protocols running under TCP/IP or the like, in which the received packets contain the instructions from the receiver station 40 to control the compositor module 20. As indicated above, in this manner zooming of and within individual views 35, 65 may be supported, as well as controlling the positioning, resolution and color depth of the various views 35, 65. Subsequent composited digital images 33, formed from subsequent images received from the video streams 21, which are generated after the configuration settings 38 are updated are generated in conformance with the updated settings 38, and thus, on the receiver station side 40, the results will appear dynamic in time.

A compositing module is provided by the program code 34, as executed by the CPU 26, and the configuration settings 38. The program code 34 includes the video amalgamation procedure 36 that uses the video input hardware 22 (and, optionally, the networking hardware 24) to receive each of the input video streams 21, or selected video input streams 21, from the respective video cameras 10 and temporarily store these video images 21 as corresponding digital images within the video scratch pad 32. Then, in accordance with the information stored in the configuration settings 38, the video amalgamation procedure 36 uses the temporary digital versions of the video images 21 to build up the corresponding composited digital image 33. That is, the video amalgamation procedure 36 scales the video images in size, color depth or both according to the configuration settings 38, to generate the various views 35, each at a position that may also be indicated within the configuration settings 38. The video amalgamation procedure 36 thus may include suitable algorithms for decoding the input video streams 21, algorithms for sizing, positioning, scaling and zooming the video images to generate the views 35, and algorithms for encoding the composite image 33 into a corresponding video stream that is subsequently transmitted along the network 5. It will be appreciated that any suitable encoding and decoding algorithms may be used to support processing of the input video streams 21.

The above process is repeated a predetermined number of times per second as determined by a corresponding setting within the configuration settings 38, creating a corresponding stream of composited video images 33, a predetermined number of which may also be stored in the video scratch pad 32, such as based on a “first-in-last-out” algorithm or the like, or based on other algorithms or routines as can be appreciated by one of ordinary skill in the art, so as to provide a predetermined amount of video buffering. The exact amount of buffering, in units of time (i.e, how many second to buffer) or frames (i.e, how many discrete images 33 to buffer), for example, may be determined and set by the configuration settings 38.

The video amalgamation code 36 interfaces with the networking hardware 24 to transmit the resultant stream of composited video images 33 to the receiver station 40 via the network 5. As noted earlier, any suitable image encoding and transmission protocol may be used to send the composited video images 33 to the receiver station 40. For example, the stream of composited video images 33 may be sent as a stream of discrete, individual, digital images 33, such as a repetitive transmission of JPEG images or the like. More preferably, the stream of composited video images 33 are processed into a conventional video stream by way of a suitable codec, such as the H.264 codec or the like, for transmission over the network 5. Other variations are certainly possible, and these two are simply provided by way of example.

The compositor module 20 may also support security algorithms to ensure that only authorized users are capable of viewing the composited digital images 33 (or video streams thereof), to change the configurations settings 38 or both. Hence, the compositing module as provided by the program code 34 may include authentication code 37 that supports both authentication procedures as known in the art prior to accepting commands received from the network 5, and may also support encryption of the composite digital images 33, or of any video streams made from the composite images 33, prior to transmission along the network 5. The compositor module 20 may also support querying from the receiver station 40 so as to determine how many active video sources 10 are available and to correlate a specific video source 10, and its corresponding video stream 21, with a particular view 35. Any suitable procedures may be supported by the authentication code 37, including secure socket layers (SSL), suitable cryptographic functions and the like.

The receiver station 40 enables a user to view the stream of composited digital images 33 on a monitor 60, and to send commands to the compositor module 20 so as to change the appearance of the matrix 64, and in particular of individual views 62 within the matrix 64, as previously discussed. Like the compositor module 20, the receiver station 40 also preferably employs a programmed model, although this is not a requirement of the invention and hardware-only implementations are certainly possible. In the preferred embodiment, however, the receiver station 40 includes one or more CPUs 49 in communications with both memory 50 and input/output hardware 42, 44, 48. The input/output hardware may include networking hardware 44 that is used to communicate via the network 5 with the networking hardware 24 of the compositor module 20; user input hardware 48 to receive user input signals 47 generated by one or more user input devices 70, such as a mouse, a keyboard or the like, and video output hardware 46 that is controlled by the CPU(s) to send a video signal 46 to the monitor 60.

The memory 50 includes program code 52 that is executable by the CPU(s) 49 to control the operations of the surveillance receiver station 40, and in particular includes user control software 54 that provides any suitable user interface to enable the user to input commands 47 into the system 100 via the user input devices 70 and thereby effect changes to configuration settings 58 present in the memory 50. The configuration settings 58 correspond to the configuration settings 38 in the compositor module 20. The program code 52 may also include authentication code 57 that corresponds to the authentication code 37 present on the compositor module 20 to facilitate secure communications with and control of the compositor module 20. In a particularly preferred embodiment, both the compositor module 20 and the receiver module 40 are configured to support a client/server architecture using standard web-based protocols and interfaces, such as HTML, Flash, Java, combinations thereof or the like, delivered over TCP/IP, optionally using a secure connection, such as SSL. Hence, from the standpoint of a user, the receiver station 40 may simply be a computing platform with a web browser, and accessing the compositor module 20 is done via HTTP requests to a known web address at which the compositor module 20 resides, using a conventional browser such as Internet Explorer, Firefox or the like.

By way of example, the user control software 54 may support positioning and sizing of each view 65 within the matrix 63 by way of a mouse, and change color depth via a keyboard command, drop-down box or the like. The configuration settings 58 are updated accordingly, and information corresponding to the resultant updated configuration settings 58 can then be transmitted over the network 5 to update the corresponding configuration settings 38 within the compositor module 20 and thereby change the overall operations of the system 100. Any suitable method may be employed to update the configuration settings 38 in accordance with the updated configuration settings 58, such as by transmitting the entire configuration settings 58, or transmitting only those settings in the configuration settings 58 that have actually been changed. The program code 52 may also support authentication routines 57 with the compositor module 20, encryption of the information corresponding to the configuration settings 58 prior to transmission to the compositor module 20, as well as decryption of information received from the compositor module 20, as previously discussed, such as decryption of the stream of composited video images 33.

The program code 52 controls the networking hardware 44 to both transmit the configuration settings 58 to the compositor module 20 and to receive video information from the compositor module 20, such as the composited digital image 33, or a video stream formed from a plurality of composited digital images 33. The program code 50 uses the received video information (i.e., composited digital images 33) to drive the video hardware 42 to output a corresponding video image 46 for display on the monitor 60. It will be appreciated that the resultant video image 46 may not be identical to the received composited digital image 33. For example, it may be sized differently, have a different color depth, have additional information overlaid upon the image 33, such as a mouse pointer, text related to each view 65, etc. Hence, the program code 52 may perform any suitable image processing upon the received composite images 33 to generate the output video signal 46 that finally drives the monitor 60.

The system 100 is capable of supporting an arbitrary number of video cameras 10 without increasing the bandwidth demands on the network 5. The system 100 also permits a user to control the size, color depth, number and position of the views 65, again without significantly affecting how much bandwidth is used on the network 5. With the user interface provided by the receiver station 40, the program code 52 can permit the user to selectively add or remove views 65, change the size of the views 65, and change the color depth of the views 65. From the standpoint of the network 5, the stream of composited digital images 33 is no more burdensome than a single video stream 21 from a single video camera 10, regardless of the number of views 35 present within the composite image 33. The user, however, continues to enjoy the full resolution offered by each video camera 10 by causing appropriate commands to be sent to the compositor module 20 that enable the user to expand a view 35 within the composite image 33, or even to zoom within a portion of a single video stream 21. That is, the configuration settings 38, 58, and corresponding video amalgamation code 36, may also support a view 35, 65 that presents a region of interest that is a sub-section of a full video image stream 21, thus permitting the user to zoom in on a specific region within a video stream 21 of a corresponding view 65.

By way of example, the user control code 54 can provide a “zoom within view” function, in which the user selects a sub-region 67 within a view 65 as a region of interest, such as by drawing a box using a mouse or by any other suitable means. The coordinates of this sub-region 67 are saved as part of the configuration settings 58, which are then transmitted to the compositor module 20 to update the corresponding configuration settings 38. Thereafter, when generating the view 35 that corresponds to the view 65 in which the “zoom within view” function was performed, rather than utilizing the entirety of the corresponding video image stream 21, instead only a sub-region in the video stream 21 that corresponds to the region of interest 67 is used to generate the resultant view 35. This sub-region in the video stream 21 is conformed so that its size matches the corresponding pixel size of the corresponding view 35. Consequently, when the final composited digital image 33 is received by the receiver station 40, the view 65 in which the “zoom within view” function was performed will be filled with only video image data from the selected region of interest 67, and thus will appear zoomed in comparison to its earlier iterations. Similarly, zoom-out functions may also be implemented.

In certain embodiments the receiver station 40 and monitor 60 form part of the same computing platform, such as a mobile phone, tablet computer or the like. Hence, the system 100 is capable of supporting portable computing devices by way of a standard cellular network 5 or the like.

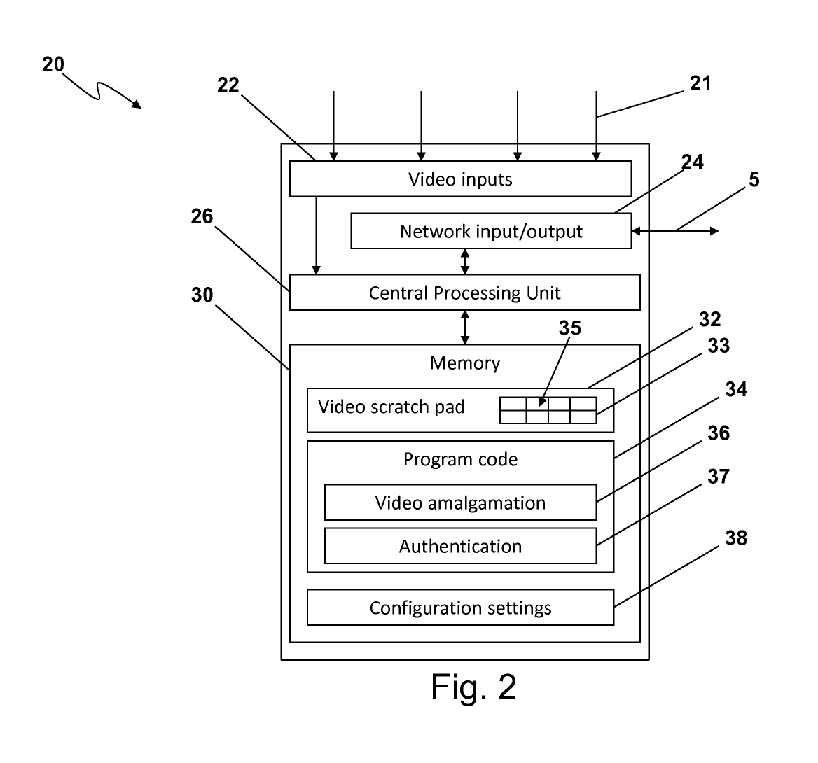

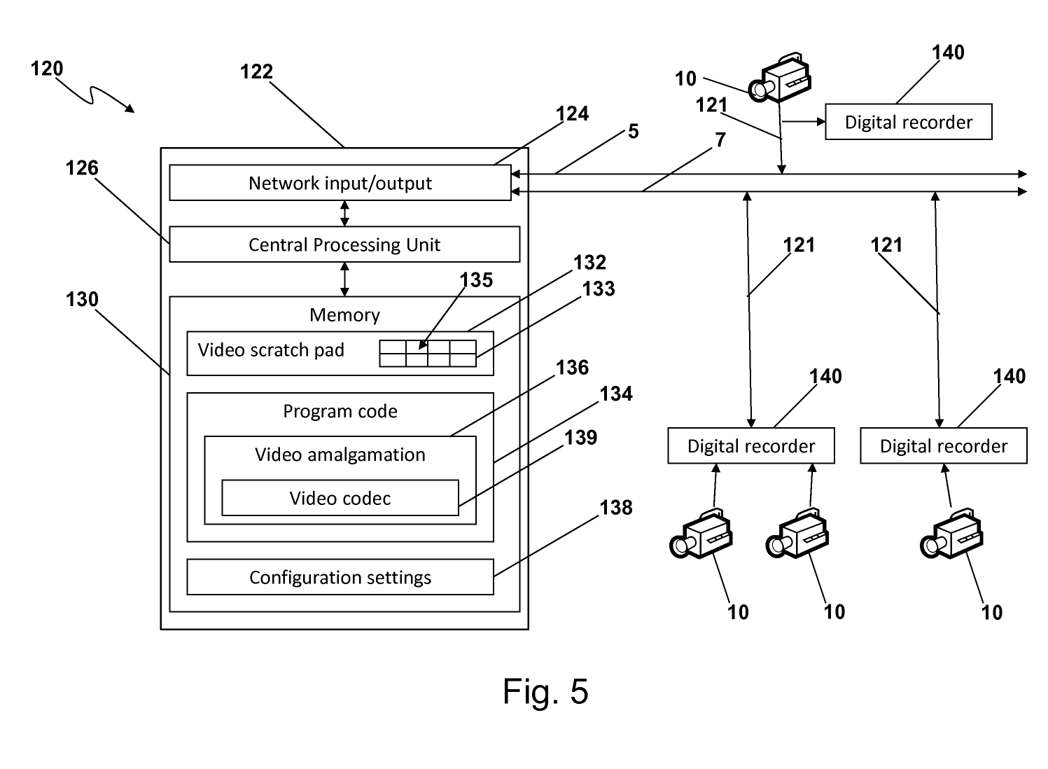

A compositor system 120 according to another embodiment is shown in FIG. 5, which may be employed in connection with the receiver station 40. The compositor system 120 includes a compositor module 122 that is similar to the module 20 depicted in FIG. 2, and includes networking hardware 124 and memory 130, both of which are communicatively coupled to one or more CPUs 126. The memory 130 includes video scratch pad memory 132 used by video amalgamation code 136 within program code 134 to generate composited digital images 133 in accordance with configuration settings 138.

However, the networking hardware 124 includes at least two inputs. A first input sends and receives data along first network 5, which is in communications with the surveillance receiver 40; each composited digital image 133, or a video stream thereof, is transmitted along the first network 5 to the surveillance receiver station 40. A second input is used to support the reception of video streams 121 obtained from a plurality of video recorders 140, video cameras 10 or both coupled to a second network 7. For purposes of the following, a video recorder is any device that is capable of recording a video signal, whether that video signal is in digital or analog form. A video recorder can thus include, by way of example, digital video recorders, network video recorders, analog video recorders and the like. The first network 5 and second network 7 are preferably not the same network, so that heavy video loading on the second network 7 by numerous video streams 121 will not impact performance on the first network 5. However, it will be appreciated that they could be part of the same network. The second network 7 may be a packet-based network. Alternatively, the second network 7 may be an analog network provided by one or more signal lines that are connected to the video recorders 140 to receive video data and to transmit control signals.

Each video recorder 140 may be coupled to one or more corresponding video cameras 10 and records imagery obtained from each camera 10 connected thereto. By way of example, it may be possible to couple all video cameras 10 to a single video recorder 140. Regardless of the topology employed, each video recorder 140 includes memory for storing a predetermined amount of video imagery received from the corresponding one or more cameras 10 to which it is coupled for recording purposes. In some instances the video recorder 140 may be in parallel to the corresponding video camera(s) 10, in which case the video camera(s) 10 directly multiplex their respective video streams 121 onto the network 7 themselves in a conventional manner. In other cases the video recorder 140 may be in series with the corresponding video camera(s) 10, in which case the video recorder 140 may act as a proxy for the camera(s) 10, passing video information received from the camera(s) 10 onto the network 7 as a corresponding video stream or streams 121 in either real-time or time-delayed. In addition, each video recorder 140 can also multiplex recorded video information onto the second network 7 in a conventional manner as a corresponding video stream 121 for transmission to the compositor module 122. It will be appreciated that in some embodiments a video recorder 140 may be physically integrated into a video camera 10, or vice versa.

Typically, when acting as a proxy, the most recent video information received by a video recorder 140 from each camera 10 is recorded and immediately forwarded on or passed through as video data 121 to the compositor module 122; in effect, each video recorder 140 acts as converter and network interface, converting video data received from the cameras 10 in a first protocol into a stream 121 of video data transmitted on the network 7 in another protocol for reception by the compositor module 122. In situations where one or more of the cameras 10 are directly coupled to the network 7, then the cameras 10 would perform this conversion themselves, and a video recorder 140 coupled to such a camera 10 would record the video stream 121 generated by the camera 10.

In a preferred embodiment, each video recorder 140 supports handling playback based upon instructions received from the compositor module 122. That is, the compositor module 122 can send individual commands to each of the video recorders 140 to cause that recorder 140 to play back a pre-recorded section of video received from the corresponding camera(s) 10. Preferably, each video recorder 140 supports rewind, fast-forward, play backward, pause, and frame-by-frame stepping (both forward and reverse) of the recorded video data, which is then transmitted as a corresponding video stream 121 onto the network 7. The compositor module 122 preferably can address each video recorder 140 individually to cause that recorder 140 to rewind, fast-forward, play backward, pause and frame-by-frame step (forward and backward) the recorded video data, jump to a specific frame (such as addressed by time, frame number or the like), and so forth. The cumulative video data 121 so received on the network 7 is then composited to create the corresponding composited digital image 133 that is subsequently forwarded to the surveillance receiver station 40 along the first network 5. In particular, in a preferred embodiment a video codec 139 is used, such as H.264 or the like, which processes the generated stream of composited digital images 133 to generate a corresponding video stream that is then sent to the receiver station 40 via the first network 5. These video codecs typically cannot handle a function such as play backward. However, from the standpoint of the video codec, the entire stream of composited digital video images 133 is moving forward in time; the time-stopped, or time reversed images are a result of controlling the video recorders 140.

It will be appreciated that the receiver station 40 and compositor module 122 are both preferably configured to support the receiver station 40 sending commands to the compositor module 122 to individually control each video recorder 140 in a desired manner, which commands the compositor module 122 receives on the first network 5 and then transmits corresponding commands back onto the second network 7, or uses to accordingly drive signal control lines connected to the video recorders 140, so as to obtain the desired user control of the video recorders 140. In this manner the user at the receiver station 40 can control rewind, fast-forward, play backward, pause and frame-by-frame stepping of each video recorder 140. Hence, in addition to providing views 35, 135 for each camera 10, it is also envisioned that a view 35, 135 could also selectively be allocated for a video recorder 140, if so desired by the end user—that is, the end user can preferably configure the number of views 35 within the composited image 33, the resolution (i.e, size) of each view 35, the position of the view 35, color depth, etc., as well as the underlying video source 121 for that view 35, which could be a video camera 10 or a video recorder 140.

As indicated, a benefit of the above arrangement is that from the standpoint of both the video codec 134 on the compositor module side 122 and on the surveillance receiver station 40 side, the video stream of composited digital images 133 is always moving forward in time; that is, there is no “rewind,” “pause” or “frame-by-frame cuing” being implemented by the video code 134 or corresponding codec on the surveillance receiver station 40. A continuous stream of composited digital images 133 is being generated and streamed along the network 5. However, the video recorders 140 that provide the input streams 121 that go into creating the underlying composited digital images 133 can support rewinding, fast-forwarding, play backward, frame-by-frame stepping and the like, as controlled by the user via the compositor module 122. Hence, within a single video stream of composited digital images 133, some of the views 135 may be in real-time, some may be showing images that are paused, some may by advanced or retreated in a frame-by-frame manner, and yet others could be presenting fast-forwarded imagery or imagery playing in reverse, all as provided by the corresponding video recorders 140 and associated video streams 121 and under the control of the user at the surveillance receiver station 40.

Yet other variations are certainly possible. For example, rather than having discrete video recording boxes 140 for the video cameras 10 as shown in FIG. 5, a setup similar to FIG. 2 may be employed, but instead the video recorder functionality is supported by way of the video scratch pad 32, with each input 21 allocated a predetermined amount of memory 30 for the purposes thereof and the program code 34 further including code to support the desired functionality of “rewinding,” “fast-forwarding,” “playing backward,” “pausing” and “stepping” each input video stream 21 using the imagery stored in the video scratch pad 32. The selected image based upon these function as pulled from the video scratch pad 32 is then used as an input image for compositing, and the final composited image is then processed by the video codec. Consequently, from the standpoint of the video codec, again, the video stream appears to be moving forward in time, although individual views, as perceived by the user, may be paused or running backward in time. Other variations are certainly possible, and the above are simply presented by way of example.

Those skilled in the art will recognize that the present invention has many applications, may be implemented in various manners and, as such is not to be limited by the foregoing embodiments and examples. Any number of the features of the different embodiments described herein may be combined into one single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there had been shown and described fundamental features of the invention as applied to being exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

What is claimed is:

1. A video system comprising a video receiver station, the video receiver station comprising:
a central processing unit (“CPU”) to control operations of the video receiver station;
networking hardware in communications with the CPU and configured to communicate with a remote device over a network;
a user input device in communication with the CPU and configured to accept input from a user;
a display in communications with the CPU; and
first memory in communications with the CPU, the first memory comprising program code executable by the CPU to perform steps comprising:
utilizing the networking hardware to receive video information from the remote device, the video information comprising a plurality of views;
causing the display to generate an image corresponding to the received video information;
accepting input from the user input device to indicate a change to at least one of a size, position, zoom or color depth of a selected view in the video information; and
utilizing the networking hardware to transmit to the remote device information corresponding to the change to at least one of the size, position, zoom or color depth of the selected view.

2. The video system according to claim 1 wherein the first memory comprises first configuration settings, the first configuration settings comprising information relating to at least one of the size, position or color depth for each of the views in the video information, and the program code is further configured to cause the CPU to perform steps comprising:
changing the first configuration settings in accordance with the change to at least one of the size, position, zoom or color depth of the selected view in the video information; and
utilizing the networking hardware to transmit information to the changed first configuration settings to the remote device.

3. The video system according to claim 1 wherein the remote device comprises:
a communication device configured to communicate with the video receiver station over the network and to accept a plurality of video streams from a plurality of video sources;
a second memory comprising second configuration settings, the second configuration settings indicating at least one of a size, position, zoom or color depth for a plurality of views in a composite image formed from the plurality of video streams; and
a compositing module configured to:
utilize the plurality of video streams to generate the composite image in accordance with the second configuration settings;
utilize the communication device to transmit the composite image to the video receiver station; and
utilize the communication device to receive from the video receiver station the information corresponding to the change to at least one of the size, position, zoom or color depth of the selected view and to update the second configuration settings in accordance with the received information corresponding to the change to at least one of the size, position, zoom or color depth of the selected view.

4. The video system according to claim 3 wherein the second configuration settings comprises a respective size and a respective position for each view in the composite image, and for each view indicated in the second configuration settings, the compositing module conforms an image received from a respective video stream for that view to have a size and position in accordance with the respective size and position indicated in the second configuration settings for that view.

5. The video system according to claim 3 wherein the second configuration settings comprises a respective zoom for each view in the composite image, and for each view indicated in the second configuration settings, the compositing module conforms a sub-region of an image received from a respective video stream for that view corresponding to the respective zoom to have a size and a position in accordance with the respective size and position for that view in the composite image.

6. The video system according to claim 3 wherein the communication device includes networking hardware configured to communicate with the video receiver station over the network, and a plurality of video inputs configured to receive a respective video stream from the plurality of video sources.

7. The video system according to claim 3 wherein at least one of the plurality of video sources is a video recorder, and the compositing module is further configured to utilize the communication device to control at least one of a pause, rewind and fast forward function of the video recorder.

8. The video system according to claim 3 wherein the compositing module is further configured to buffer in the second memory a plurality of images from at least one of the video sources and utilize a corresponding buffered image in accordance with an instruction received from the video receiver station when generating the composite image.

9. The video system according to claim 3 wherein the compositing module comprises at least a CPU and program code stored in the second memory and executable by the CPU.

10. A video system comprising a video compositing device, the video compositing device comprising:
at least a communication device configured to communicate with a video receiver station over a network and to accept a plurality of video streams from a plurality of video sources;
a first memory comprising first configuration settings, the first configuration settings indicating at least one of a size, position, zoom or color depth for a plurality of views in a composite image formed from the plurality of video streams; and
a compositing module configured to:
utilize the plurality of video streams to generate the composite image in accordance with the first configuration settings;
utilize the communication device to transmit the composite image to the video receiver station; and
utilize the communication device to receive from the video receiver station information corresponding to a change to at least one of the size, position, zoom or color depth of a selected view in the composite image and to update the first configuration settings in accordance with the received information corresponding to the change to at least one of the size, position, zoom or color depth of the selected view.

11. The video system of claim 10 wherein the video receiver station comprises:
at least a central processing unit (“CPU”) to control operations of the video receiver station;
networking hardware in communications with the CPU and configured to communicate with the video compositing device over the network;
a user input device in communications with the CPU and configured to accept input from a user;
a display in communications with the CPU; and
second memory in communications with the CPU, the second memory comprising program code executable by the CPU to perform steps comprising:
utilizing the networking hardware to receive the composite image from the video compositing device;
causing the display to generate an image corresponding to the composite image;
accepting input from the user input device to indicate a change to at least one of a size, position, zoom or color depth of the selected view in the composite image; and
utilizing the networking hardware to transmit to the video compositing device the information corresponding to the change to at least one of the size, position, zoom or color depth of the selected view.

12. The video system according to claim 11 wherein the second memory comprises second configuration settings, the second configuration settings comprising information relating to at least one of the size, position or color depth for each of the views in the composite image, and the program code is further configured to cause the CPU to perform steps comprising:
changing the second configuration settings in accordance with the change to at least one of the size, position, zoom or color depth of the selected view in the composite image; and
utilizing the networking hardware to transmit information to the changed second configuration settings to the video compositing device.

13. The video system according to claim 10 wherein the first configuration settings comprises a respective size and a respective position for the selected view in the composite image, and for the selected view indicated in the first configuration settings, the compositing module conforms an image received from a respective video stream for the selected view to have a size and position in accordance with the respective size and position indicated in the first configuration settings for the selected view.

14. The video system according to claim 13 wherein the second configuration settings comprises a respective size and a respective position for each view in the composite image, and for each view indicated in the second configuration settings, the compositing module conforms an image received from a respective video stream for that view to have a size and position in accordance with the respective size and position indicated in the second configuration settings for that view.

15. The video system according to claim 10 wherein the first configuration settings comprises a zoom for the selected view in the composite image, and the compositing module conforms a sub-region corresponding to the zoom for an image received from a video stream for the selected view to have a size and a position in accordance with the respective size and position of the selected view in the composite image.

16. The video system according to claim 15 wherein the first configuration settings comprises a respective zoom for each view in the composite image, and for each view indicated in the first configuration settings, the compositing module conforms a sub-region of an image received from a respective video stream for that view corresponding to the respective zoom to have a size and a position in accordance with the respective size and position for that view in the composite image.

17. The video system according to claim 10 wherein the communication device includes networking hardware configured to communicate with the video receiver station over the network, and a plurality of video inputs configured to receive a respective video stream from the plurality of video sources.

18. The video system according to claim 10 wherein at least one of the plurality of video sources is a video recorder, and the compositing module is further configured to utilize the communication device to control at least one of a pause, rewind and fast forward function of the video recorder.

19. The video system according to claim 10 wherein the compositing module is further configured to buffer in the first memory a plurality of images from at least one of the video sources and utilize a corresponding buffered image in accordance with an instruction received from the video receiver station when generating the composite image.

20. The video system according to claim 10 wherein the compositing module comprises at least a CPU and program code stored in the first memory and executable by the CPU.

21. A method for providing a plurality of video images to a video receiver station, the method comprising:
obtaining a respective image from a plurality of video streams generated by a plurality of video sources;
determining a size and location of each image in a corresponding view within a composite image;
conforming a size of each image to the respective size for that image in the composite image;
locating each conformed image in the respective view within the composite image; and
utilizing a network to transmit the composite image to the video receiver station.

22. The method of claim 21 further comprising:
receiving from the video receiver station an instruction to change a size of a selected view in the composite image;
conforming a subsequent image obtained from a corresponding video stream for the selected view to the changed size;
locating the conformed subsequent image in a respective view within a subsequent composite image; and
utilizing the network to transmit the subsequent composite image to the video receiver station.

23. The method of claim 21 further comprising:
receiving from the video receiver station an instruction to change a location of a selected view in the composite image;
conforming a subsequent image obtained from a corresponding video stream for the selected view to a respective size for the selected view;
locating the conformed subsequent image in the changed location within a subsequent composite image; and
utilizing the network to transmit the subsequent composite image to the video receiver station.

24. The method of claim 21 further comprising:
receiving from the video receiver station an instruction to change a zoom of a selected view in the composite image;
conforming a sub-region corresponding to the zoom of a subsequent image obtained from a corresponding video stream for the selected view to a respective size for the selected view;
locating the conformed sub-region of the subsequent image in a respective view within a subsequent composite image; and
utilizing the network to transmit the subsequent composite image to the video receiver station.
